(19) United States
(12) Patent Application Publication
(10) Pub. No.: US 2007/0259765 A1
(43) Pub. Date: Nov. 8, 2007

(54) Plastic bag sealing device

(76) Inventor: Chun-Shan Chen, Tainan Hsien (TW)

Correspondence Address: Chun-Shan Chen, P.O. BOX 90, Tainan City, 70499, TW

(21) Appl. No.: 11/429,192

(22) Filed: May 8, 2006

(51) Int. Cl. B31B 1/64

(52) U.S. Cl. 493/195

(57) ABSTRACT

A plastic bag sealing device includes a work table, a silica gel roller fixed on the work table, a material intake press roller fixed on the work table at one side of the silica gel roller, a material outlet press roller fixed on the work table at one side of the silica gel roller and separated from the material intake press roller, A plurality of rotating shafts are fixed spaced apart on with work table around the silica gel roller, respectively having a sealing blade secured thereon. When rotated to contact with the silica gel roller, the sealing blades will orderly carry out sealing at a same sealing portion of a plastic bag. The plastic bag sealing device can quickly perform sealing at the same sealing portion of a plastic bag for several times to insure firmness of the sealed portion of the plastic bag, substantially downsized.

### BACKGROUND OF THE INVENTION

1. Field of the Invention

This invention relates to a plastic bag sealing device, particularly to one able to quickly carry out sealing at the same sealing portion of a plastic bag for several times for insuring firmness of the sealed portion, applicable to comparatively thick plastic bags, diminishing the size of a sealing device and greatly elevating economic gain.

2. Description of the Prior Art

A conventional plastic bag-sealing machine, as shown in FIGS. 1 and 2, includes a worktable 10 provided thereon with a material intake press roller 11. A guide roller 12 is positioned beside the material intake press roller 11, a silica gel roller 13 is provided near the guide roller 12 and a material outlet guide roller 14 is disposed beside the silica gel roller 13. A sealing device 15 is positioned opposite to the silica gel roller 13 and provided with a rotating shaft 16 having a sealing blade 17 fixed thereon. Plastic bags 19 are wound to pass the material intake press roller 11, the guide roller 12, the silica gel roller 13 and the material outlet guide roller 14 to be conveyed forward, and the sealing blade 17 is rotated together with the rotating shaft 16. When the sealing blade 17 is rotated for a circle and contacts with silica gel roller 13, as shown in FIG. 2, it will perform sealing at the sealing portion 18 of a plastic bag 19. When the sealing blade 17 is rotated together with the rotating shaft 16 for a circle, the plastic bags 19 will be conveyed by the material outlet guide roller 14 for a distance that is exactly equivalent to the length of a plastic bag 19, and when rotated for a second circle and contacting with the silica get roller 13 again, the sealing blade 17 will carry out sealing for another plastic bag 19. Such incessantly circulating movement enables the sealing machine 1 to perform sealing automatically. However, in order to tightly seal a plastic bag 19, the conventional plastic bag sealing machine 1 has to reduce the conveying speed of the plastic bags 19 and the rotating speed of the sealing blade 17 to enable the sealing blade 17 to stay longer at the sealing portion 18 of a plastic bag 19 for insuring firmness of the sealed portion of the plastic bag 19, thus reducing sealing speed and producing speed of plastic bags. In addition, due to being sealed only one time by the sealing blade 17, the sealed portion of a plastic bag is insufficient in strength, likely to cause disqualified products; therefore, the conventional plastic bag-sealing machine 1 is only applicable to comparatively thin plastic bags 19. Moreover, the conventional plastic bag-sealing machine 1 has all its components transversely disposed in a line on the worktable 10, taking too much space.

### SUMMARY OF THE INVENTION

The objective of the invention is to offer a plastic bag-sealing device applicable to comparatively thick plastic bags, able to carry out sealing with quickness and with great strength, diminishing the size of a sealing device and greatly elevating economic gain.

The plastic bag sealing device in the present invention includes a work table, a silica gel roller fixed on the work table, a material intake press roller positioned on the work table at one side of the silica roller, and a material outlet press roller also positioned on the work table at one side of the silica gel roller. Both the material intake press roller and the material outlet pres roller all press on the silica gel roller. Further, a plurality of rotating shafts is fixed on the worktable spaced apart around the other side of the silica gel roller, respectively having a sealing blade secured thereon. When the sealing blades are rotated together with the rotating shafts, closely contacting with the silica gel roller, they will carry out sealing at the sealing portion of a plastic bag in due order.

### BRIEF DESCRIPTION OF DRAWINGS

This invention will be better understood by referring to the accompanying drawings, wherein:

FIG. 1 is a cross-sectional view of a conventional plastic bag-sealing machine;

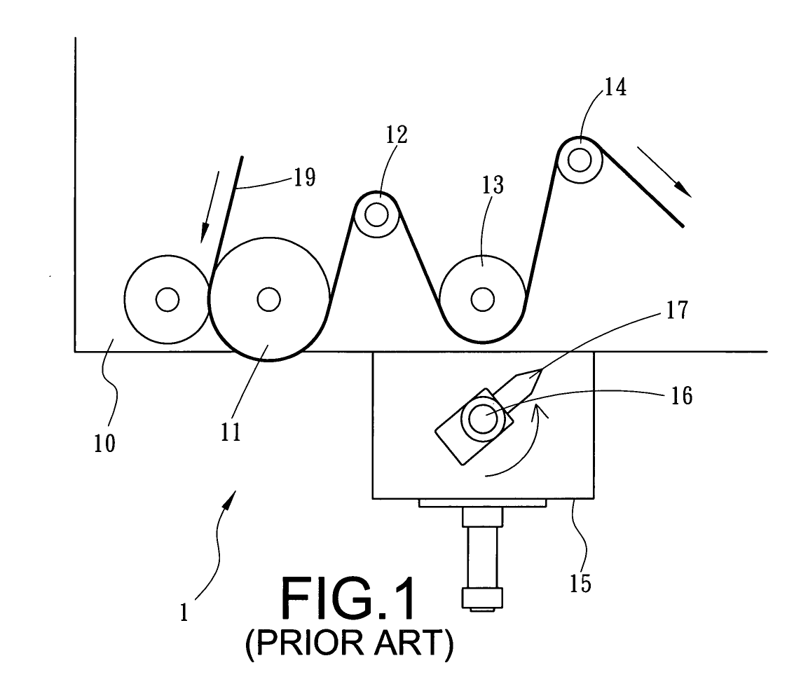

FIG. 2 is another cross-sectional view of the conventional plastic bag-sealing machine;

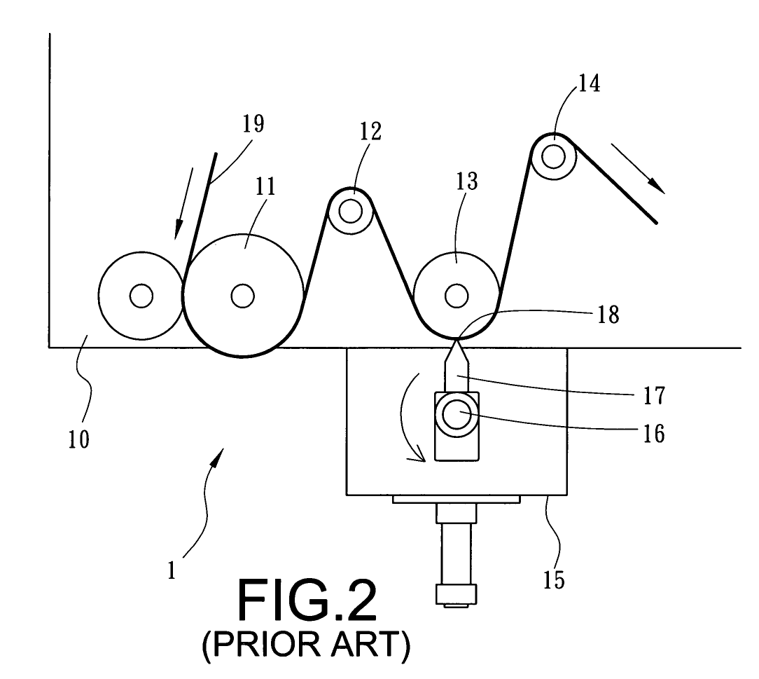

FIG. 3 is a cross-sectional view of a plastic bag-sealing device having a first sealing blade carrying out sealing at the sealing portion of a plastic bag in the present invention;

FIG. 4 is a cross-sectional view of the plastic bag sealing device having a second sealing blade carrying out sealing at the same sealing portion of the plastic bag in the present invention; and

FIG. 5 is a cross-sectional view of the plastic bag-sealing device having a third sealing blade carrying out sealing at the same sealing portion of the plastic bag in the present invention.

### DETAILED DESCRIPTION OF THE PREFERRED EMBODIMENT

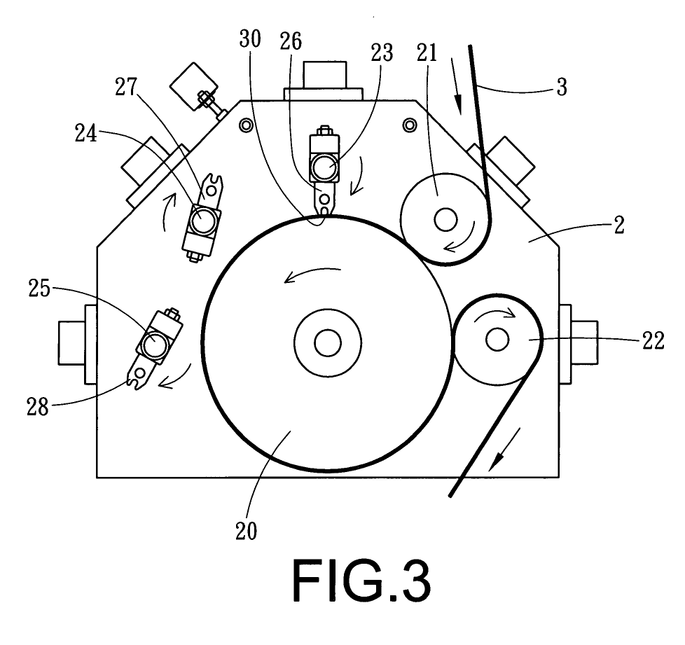

A preferred embodiment of a plastic bag sealing device in the present invention, as shown in FIG. 3, includes a work table 2, a silica gel roller 20 fixed on the work table 2, a material intake press roller 21 fixed on the work table 2 at one side of the silica gel roller 20, and a material outlet press roller 22 fixed on the work table 2 at one side of the silica gel roller and spaced apart from the material intake roller 21. The material intake roller 21 and the material outlet press roller 22 all press on the silica gel roller 20. Further, a first rotating shaft 23, a second rotating shaft 24 and a third rotating shaft 25 are all fixed on the work table, spaced apart around the other side of the silica gel roller 20, respectively fixed thereon with a first sealing blade 26, a second sealing blade 27, and a third rotating shaft 25. When the first, the second and the third sealing blade 26, 27 and 28 are rotated to contact with the silica gel roller 20 in due order, they will orderly and respectively carry out sealing at the same sealing portion of a plastic bag 3.

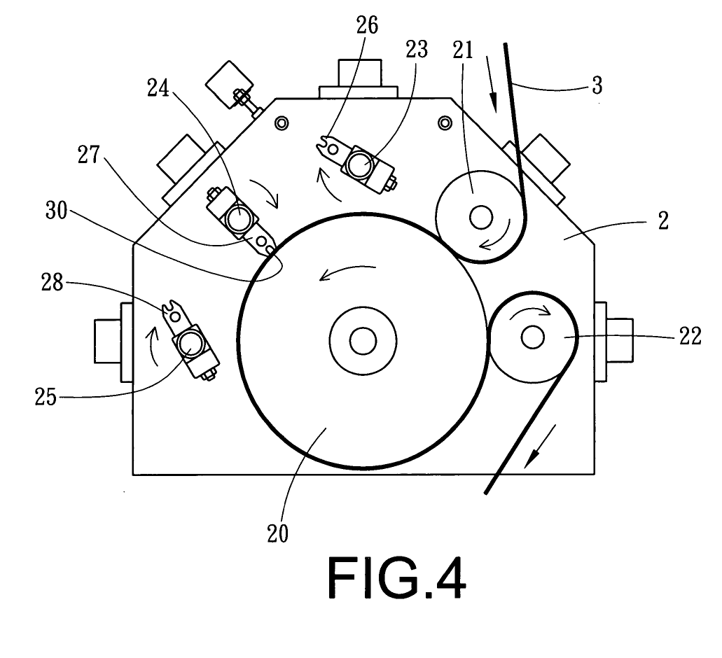

In using, as shown in FIGS. 3, 4 and 5, firstly, a sheet of continuous plastic bags 3 is wound through between the material intake press roller 21 and the silica gel roller 20 as well as the material outlet press roller 22, conveyed through between the material intake press roller 21 and the silica gel roller 20 and around the silica gel roller 20 and then out through between the material outlet press roller 22 and the silica gel roller 20 and around the material outlet press roller 22. When the plastic bag 3 is conveyed forward by the material intake press roller 21, and the silica gel roller 20 and the material outlet press roller 22, the first sealing blade 26 will be rotated together with the first rotating shaft 23, and when the first sealing blade 26 closely contacts with the silica gel roller 20, as shown in FIG. 3, it will carry out first sealing at the sealing portion of a plastic bag 3. After being sealed, the sealing portion 30 of the plastic bag 3 will be conveyed to the spot where the second sealing blade 27 is located, and meanwhile the second sealing blade 27 is rotated together with the second rotating shaft 24 to contact with the silica gel roller 20 and the first sealing blade 26 is rotated to leave the silica gel roller 20, as shown in FIG. 4.

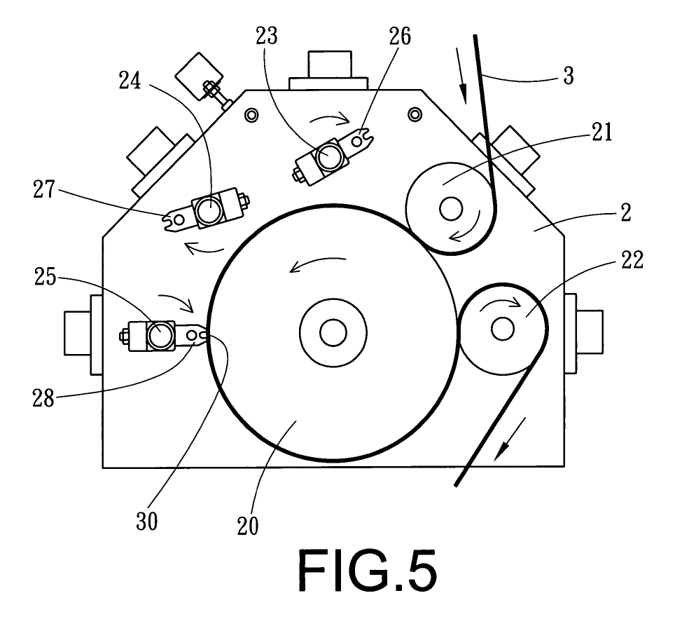

Next, the second sealing blade 27 is actuated to perform second sealing at the same sealing portion 30 of the plastic bag 3. After being sealed by the second sealing blade 27, the same sealing portion 30 of the plastic bag 3 will be conveyed to the spot where the third sealing blade 28 is located, and simultaneously, the third sealing blade 28 is rotated together with the third rotating shaft 25 to contact with the silica gel roller 20 and the second sealing blade 27 is rotated to leave the silica gel roller 20, as shown in FIG. 5.

Next, the third sealing blade 28 functions to carry out third sealing at the same sealing portion 30 of the plastic bag 3, and after being sealed by the third sealing blade 28, the plastic bag 3 will be conveyed to the material outlet press roller 22 by the silica gel roller 20 and then sent out by the material outlet press roller 22, and the third sealing blade 28 will be rotated to leave the silica gel roller 20, as shown in FIG. 3, thus finishing sealing work of the plastic bags 3.

As soon as the third sealing blade 28 is rotated together with the third rotating shaft 25 to leave the silica gel roller 20, the first sealing blade 26 is again rotated together with the first rotating shaft 23 to contact with the silica gel roller 20 to carry out first sealing for another plastic bag 3, as shown in FIG. 3.

By repeating foresaid circulating movement, the plastic bag sealing device can continuously carry out sealing for the plastic bags 3, and the same sealing portion 30 of a plastic bag 3 can be sealed three times, enabling the plastic bag 3 to be firmly sealed with great strength. Therefore, the plastic bag-sealing device of this invention is able to carry out sealing comparatively thick plastic bags 3, impossible to cause disqualified products. Moreover, the same sealing portion of a plastic bag 3 can be quickly sealed three times, able to elevate production capabilities, and additionally the plastic bag sealing device in this invention is designed in a circular-motion type, taking less space and greatly enhancing economic gain.

While the preferred embodiment of the invention has been described above, it will be recognized and understood that various modifications may be made therein and the appended claims are intended to cover all such modifications that may fall within the spirit and scope of the invention.

What is claimed is:

1. A plastic bag sealing device comprising:
a work table;
a silica gel roller fixed on said work table;
a material intake press roller fixed on said work table at one side of said silica gel roller;
a material outlet press roller fixed on said work table at one side of said silica gel roller separated from said material intake roller, said material intake press roller and said material outlet press roller both pressing on said silica gel roller;
a plurality of rotating shafts positioned on said work table and spaced apart around the other side of said silica gel roller and respectively having a sealing blade secured thereon; and,
said sealing blades performing sealing of a plastic bag respectively on a same portion in due time when rotated to contact with said silica gel roller.

2. The plastic bag sealing device as claimed in claim 1, wherein said rotating shafts are composed of a first rotating shaft, a second rotating shaft and a third rotating shaft, a first sealing blade is fixed on said first rotating shaft, a second sealing blade on said second rotating shaft, and a third sealing blade on said third rotating shaft.
